(19) United States
(12) Patent Application Publication
(10) Pub. No.: US 2021/0285273 A1
(43) Pub. Date: Sep. 16, 2021

(54) DETACHABLE AND REPLACEABLE SHOWER DOOR ASSEMBLY WITH BUFFER FUNCTION

(71) Applicant: Huilian FANG, Zhejiang (CN)

(72) Inventor: Huilian FANG, Zhejiang (CN)

(21) Appl. No.: 16/815,572

(22) Filed: Mar. 11, 2020

(51) Int. Cl. E05F 5/00; A47K 3/34

(52) U.S. Cl. CPC E05F 5/003; A47K 2003/305; A47K 3/34

(57) ABSTRACT

The invention discloses a detachable and replaceable shower door assembly with a buffer function, which comprises a room body, a door, a cross bar, a pulley, a buffer and an anti-bounce member. The buffer is detachably and replaceably arranged in an accommodating cavity, and the anti-bounce member is cooperatively disposed to allow the perfect combination of the buffer and the anti-bounce member, which provides a simple structure, allows easy push and pull, prevents hands from being gripped, causes little sound when the door is opened or closed, provides convenience in disassembly and stable operation, and avoids taking up space, thus ensuring the soft and stable opening or closing of the shower door.

### FIELD OF THE INVENTION

The invention relates to the technical field of bathrooms, and particularly to a detachable and replaceable shower door assembly with a buffer function.

### BACKGROUND OF THE INVENTION

Shower rooms are separate shower compartments. Modern homes have higher and higher requirements for bathroom facilities, and many families desire to have a separate bathing space, but bathing facilities and sanitary ware can only be placed in one room due to the limited sanitary space in the room. A shower room makes full use of a corner of the room, and a shower area is clearly divided by a fence to form a relatively independent bathing space.

The existing shower rooms with sliding doors are equipped with buffers on the doors. However, if the buffers of the shower rooms currently on the market are broken, the entire shower door needs to be disassembled to replace the defective structure of the buffer, resulting in inconvenience in use and maintenance. Therefore, it is necessary to find out a solution to the above problem.

### SUMMARY OF THE INVENTION

For this reason, a main object of the invention is to provide a detachable and replaceable shower door assembly with a buffer function in view of the disadvantages of the prior art, wherein the structure can effectively avoid the problem of inconvenience in use and maintenance of an existing shower door.

To achieve the above object, the invention employs the following technical solutions.

A detachable and replaceable shower door assembly with a buffer function comprises a room body, a door, a cross bar, a pulley, a buffer and an anti-bounce member; wherein the door can be translationally opened or closed at a doorway of the room body; the cross bar is fixed on the room body and spans an upper part of the doorway, and has an accommodating cavity with an opening facing downwards; the pulley is rotatably fixed on the door and can slide against an upper part of the cross bar to move back and forth along the cross bar; the buffer is detachably and replaceably arranged in the accommodating cavity, and has a clamping slot; and the anti-bounce member is fixed on the door and located below the cross bar, and has a buffer member inserted into the clamping slot.

Preferably, the buffer member is fixed on the door through an eccentric shaft, a cover plate and a screw; and the screw sequentially passes through the cover plate and the eccentric shaft to be fixedly connected to the buffer member.

Preferably, the buffer member has a round or square cross section.

Preferably, the cross bar is made of stainless steel and has a diameter of 25 mm.

Preferably, both ends of the buffer are fixedly connected to the cross bar by screws.

Preferably, the door is made of toughened glass.

Preferably, two said pulleys are arranged and respectively located on left and right sides of the door.

Preferably, the cross bar is provided with a decorative cover for covering the buffer.

Preferably, the decorative cover is made of stainless steel.

Compared with the prior art, the invention has significant advantages and beneficial effects. Specifically, it can be seen from the above technical solutions that:

the buffer is detachably and replaceably arranged in the accommodating cavity, and the anti-bounce member is cooperatively disposed to allow the perfect combination of the buffer and the anti-bounce member, which provides a simple structure, allows easy push and pull, prevents hands from being gripped, causes little sound when the door is opened or closed, provides convenience in disassembly and stable operation, and avoids taking up space, thus ensuring the soft and stable opening or closing of the shower door.

In order to explain the structural features and effects of the invention more clearly, the invention will be described below in detail with reference to the drawings and particular embodiments.

### BRIEF DESCRIPTION OF THE DRAWINGS

FIG. 1 is a schematic perspective view of a first preferred embodiment of the invention;

FIG. 2 is a partially exploded view of the first preferred embodiment of the invention;

FIG. 3 is a schematic perspective view of a second preferred embodiment of the invention;

FIG. 4 is a partially exploded view of the second preferred embodiment of the invention; and

FIG. 5 is a schematic perspective view of a third preferred embodiment of the invention.

Description of reference numerals:

| | |
|---|---|
| 10. | room body |
| 11. | doorway |
| 20. | door |
| 30. | cross bar |
| 31. | accommodating cavity |
| 40. | pulley |
| 50. | buffer |
| 51. | clamping slot |
| 60. | anti-bounce member |
| 61. | buffer member |
| 62. | eccentric shaft |
| 63. | cover plate |
| 64. | screw |
| 70. | decorative cover |

### DETAILED DESCRIPTION OF THE INVENTION

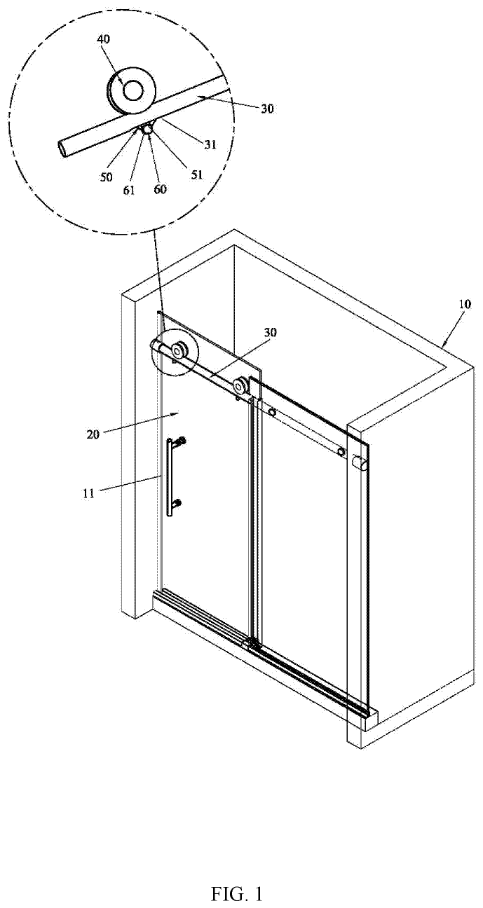

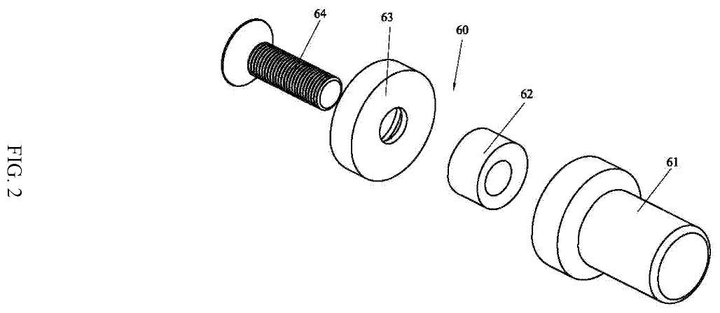

Referring to FIGS. 1 and 2, a specific structure of a first preferred embodiment of the invention is shown to comprise a room body 10, a door 20, a cross bar 30, a pulley 40, a buffer 50 and an anti-bounce member 60.

The door 20 can be translationally opened or closed at a doorway 11 of the room body 10. The door 20 is made of toughened glass.

The cross bar 30 is fixed on the room body 10 and spans an upper part of the doorway 11. The cross bar 30 has an accommodating cavity 31 with an opening facing downwards. In this embodiment, the cross bar 30 is made of stainless steel and has a diameter of 25 mm.

The pulley 40 is rotatably fixed on the door 20 and can slide against an upper part of the cross bar 30 to move back and forth along the cross bar 30; and two said pulleys 40 are arranged and respectively located on left and right sides of the door 30, and the pulleys 40 have a diameter of 70 mm.

The buffer 50 is detachably and replaceably arranged in the accommodating cavity 31. The buffer 50 has a clamping slot 51. Both ends of the buffer 50 are fixedly connected to the cross bar 30 by screws (not shown).

The anti-bounce member 60 is fixed on the door 20 and located below the cross bar 30. The anti-bounce member 60 has a buffer member 61 inserted into the clamping slot 51. In this embodiment, the buffer member 61 is fixed on the door 20 through an eccentric shaft 62, a cover plate 63 and a screw 64; the screw 64 sequentially passes through the cover plate 63 and the eccentric shaft 62 to be fixedly connected to the buffer member 61; the rotation of the eccentric shaft 62 enables the buffer member 61 to be adjusted upward or downward by 4 mm to facilitate adjustment and mounting; the screw 64 is an M6 screw; and the buffer member 61 has a round cross section.

A method of using this embodiment will be described below in detail.

During use, when the door 20 is translationally opened or closed, the anti-bounce member 60 collides with a guide block of the buffer 50 under an inertial force to complete the slow sliding opening or closing of the door 20; the door 20 is opened in the same direction of sliding the door; and the perfect combination of the buffer 50 and the anti-bounce member 60 in the product provides a simple structure, allows easy push and pull, prevents hands from being gripped, causes little sound when the door is opened or closed, provides convenience in disassembly and stable operation, and avoids taking up space, thus ensuring the soft and stable opening or closing of the shower door 20. If there is a possibility that the buffer 50 is defective, a user can unscrew the screws on the cross bar 30 to easily remove and replace the buffer.

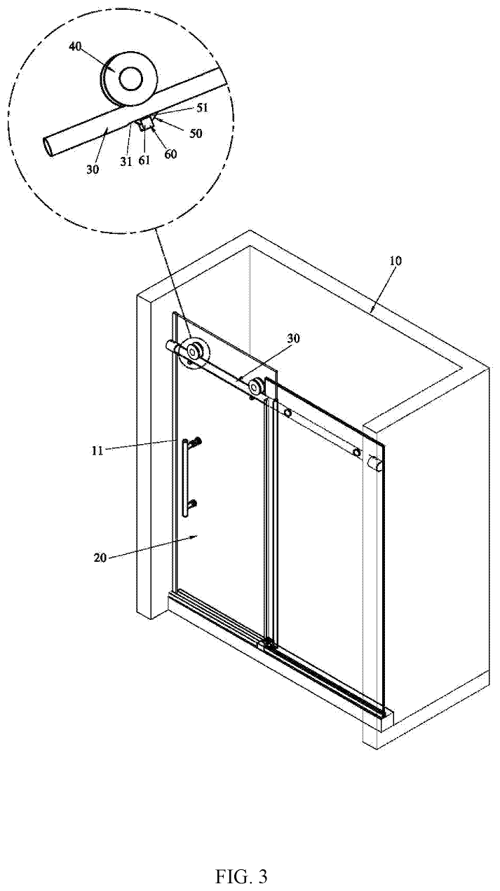

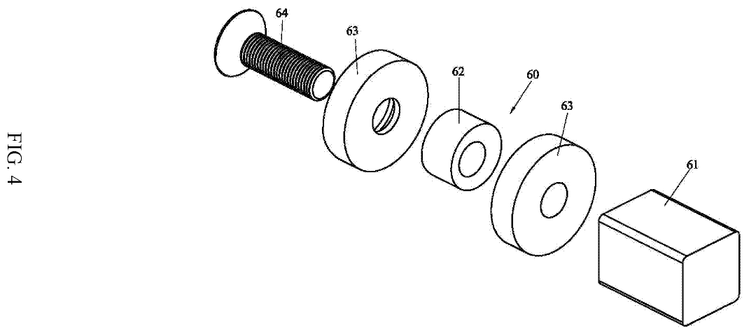

Referring to FIGS. 3 and 4, a specific structure of a second preferred embodiment of the invention is shown. The specific structure of this embodiment is substantially the same as that of the foregoing first preferred embodiment, except that:

in this embodiment, the buffer member 61 has a square cross section, so that the probability of collision between the buffer member 61 and the buffer 50 is 100%, and the structure is more stable; and two said cover plates 63 are arranged and respectively located on inner and outer sides of the door 20, and the eccentric shaft 62 is located between the two cover plates 63.

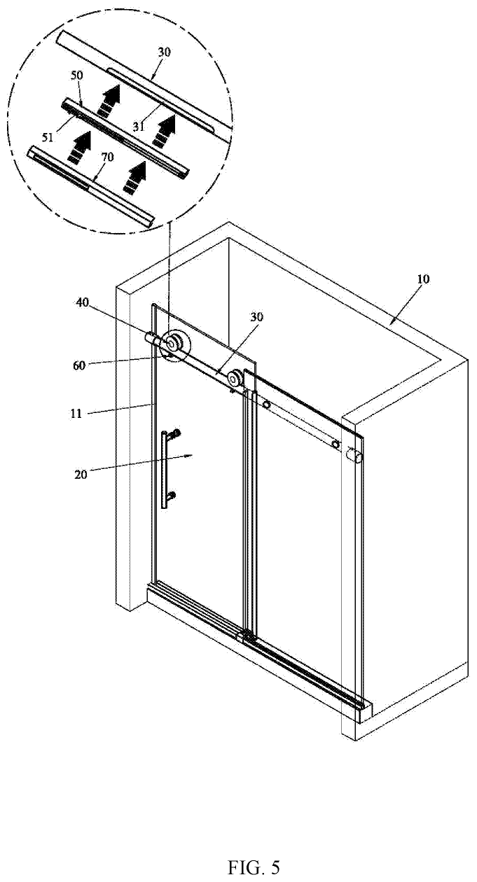

Referring to FIG. 5, a specific structure of a third preferred embodiment of the invention is shown. The specific structure of this embodiment is substantially the same as that of the foregoing second preferred embodiment, except that: in this embodiment, the cross bar 30 is provided with a decorative cover 70 for covering the buffer 50 so that the overall structure of the product is more aesthetic; and the decorative cover 70 is made of stainless steel.

The design focus of the invention is as follows: the buffer is detachably and replaceably arranged in the accommodating cavity, and the anti-bounce member is cooperatively disposed to allow the perfect combination of the buffer and the anti-bounce member, which provides a simple structure, allows easy push and pull, prevents hands from being gripped, causes little sound when the door is opened or closed, provides convenience in disassembly and stable operation, and avoids taking up space, thus ensuring the soft and stable opening or closing of the shower door.

The technical principles of the invention have been described above with reference to particular embodiments. These descriptions are only for the purpose of explaining the principles of the invention, and cannot be construed in any way as limiting the protection scope of the invention. Based on the explanation herein, those skilled in the art can contemplate other particular embodiments of the invention without inventive work, and these embodiments will fall within the protection scope of the invention.

1. A detachable and replaceable shower door assembly with a buffer function, comprising a room body, a door, a cross bar, a pulley, a buffer and an anti-bounce member; wherein the door can be translationally opened or closed at a doorway of the room body; the cross bar is fixed on the room body and spans an upper part of the doorway, and has an accommodating cavity with an opening facing downwards; the pulley is rotatably fixed on the door and can slide against an upper part of the cross bar to move back and forth along the cross bar; the buffer is detachably and replaceably arranged in the accommodating cavity, and has a clamping slot; and the anti-bounce member is fixed on the door and located below the cross bar, and has a buffer member inserted into the clamping slot.

2. The detachable and replaceable shower door assembly with a buffer function according to claim 1, wherein the buffer member is fixed on the door through an eccentric shaft, a cover plate and a screw; and the screw sequentially passes through the cover plate and the eccentric shaft to be fixedly connected to the buffer member.

3. The detachable and replaceable shower door assembly with a buffer function according to claim 1, wherein the buffer member has a round or square cross section.

4. The detachable and replaceable shower door assembly with a buffer function according to claim 1, wherein the cross bar is made of stainless steel and has a diameter of 25 mm.

5. The detachable and replaceable shower door assembly with a buffer function according to claim 1, wherein both ends of the buffer are fixedly connected to the cross bar by screws.

6. The detachable and replaceable shower door assembly with a buffer function according to claim 1, wherein the door is made of toughened glass.

7. The detachable and replaceable shower door assembly with a buffer function according to claim 1, wherein two said pulleys are arranged and respectively located on left and right sides of the door.

8. The detachable and replaceable shower door assembly with a buffer function according to claim 1, wherein the cross bar is provided with a decorative cover for covering the buffer.

9. The detachable and replaceable shower door assembly with a buffer function according to claim 8, wherein the decorative cover is made of stainless steel.
